(19) United States
(12) Patent Application Publication
(10) Pub. No.: US 2018/0266873 A1
(43) Pub. Date: Sep. 20, 2018

(54) Fluid System

(71) Applicant: Castrol Limited, Pangbourne, Reading (GB)

(72) Inventors: Steven Paul Goodier, Underhill, Moulsford (GB); Oliver Paul Taylor, Reading (GB); Christopher Dawson, Royston (GB); Ben Yeats, Royston (GB)

(21) Appl. No.: 15/762,432

(22) PCT Filed: Sep. 23, 2016
(86) PCT No.: PCT/EP2016/072767

§ 371 Date: Mar. 22, 2018

(30) Foreign Application Priority Data
Sep. 23, 2015 (GB) 1516858.6

(51) Int. Cl. G01F 23/26; F01M 11/04; F01M 11/12; F16N 19/00

(52) U.S. Cl. CPC G01F 23/263; F01M 11/04; G01F 23/0076; F16N 19/003; F01M 2011/0483; F01M 11/12

(57) ABSTRACT

Replaceable fluid containers for engines, such as those comprising at least one fluid port adapted to couple with a fluid circulation system of the engine when the replaceable container is coupled to a dock, a data provider configured to provide analog data characteristic of at least one of the fluid and the container, an analog-to-digital converter configured to convert analog data from the data provider into digitized data, and an interface configured to provide the digitized data unprocessed to an interface of the dock for supply to a processor configured to process the unprocessed digitized data to provide an indication of a property of at least one of the fluid and the container, related replaceable fluid containers for engines and associated methods of determining a property of a fluid in a replaceable fluid container for an engine.

The present disclosure relates to a fluid system such as a fluid container and to a method for determining a property of a fluid in the fluid container.

Many vehicle engines use one or more fluids for their operation. Such fluids are often liquids. For example, internal combustion engines use liquid lubricating oil. Also, electric engines use fluids which can provide heat exchange functionality, for example to cool the engine and/or to heat the engine, and/or to cool and heat the engine during different operating conditions. The heat exchange functionality of the fluids may be provided in addition to other functions (such as a primary function) which may include for example charge conduction and/or electrical connectivity. Such fluids are generally held in reservoirs associated with the engine and may require periodic replacement.

Such fluids often are consumed during operation of the engine. The properties of such fluids may also degrade with time so that their performance deteriorates, resulting in a need for replacement with fresh fluid. Such replacement may be an involved and time-consuming process For example, replacement of engine lubricating oil in a vehicle engine usually involves draining the lubricating oil from the engine sump. The process may also involve removing and replacing the engine oil filter. Such a procedure usually requires access to the engine sump drain plug and oil filter from the underside of the engine, may require the use of hand tools and usually requires a suitable collection method for the drained lubricating oil.

Aspects and embodiments of the present disclosure are directed to the determination of a property of a fluid in a replaceable fluid container.

Some embodiments will now be described, by way of example only, with reference to the accompanying drawings, in which:

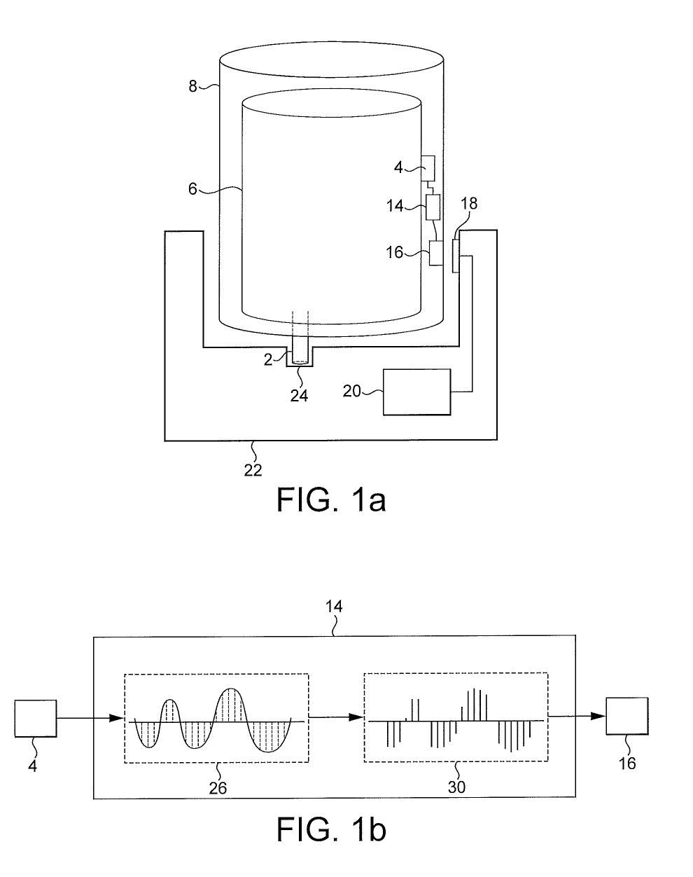

FIG. 1a shows a schematic illustration of a replaceable fluid container having a reference sensor and a measurement sensor with the replaceable fluid container positioned within a dock;

FIG. 1b illustrates an analog-to-digital converter converting an unprocessed analog signal to an unprocessed digital signal;

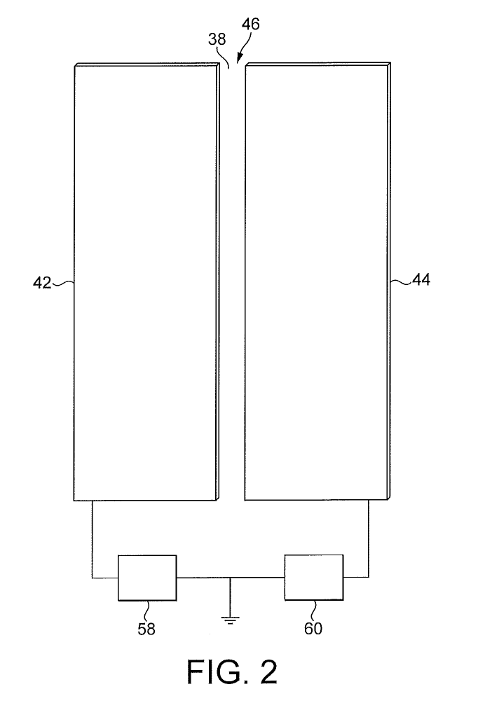

FIG. 2 illustrates diagrammatically generation of a field in a fluid channel between two electrodes;

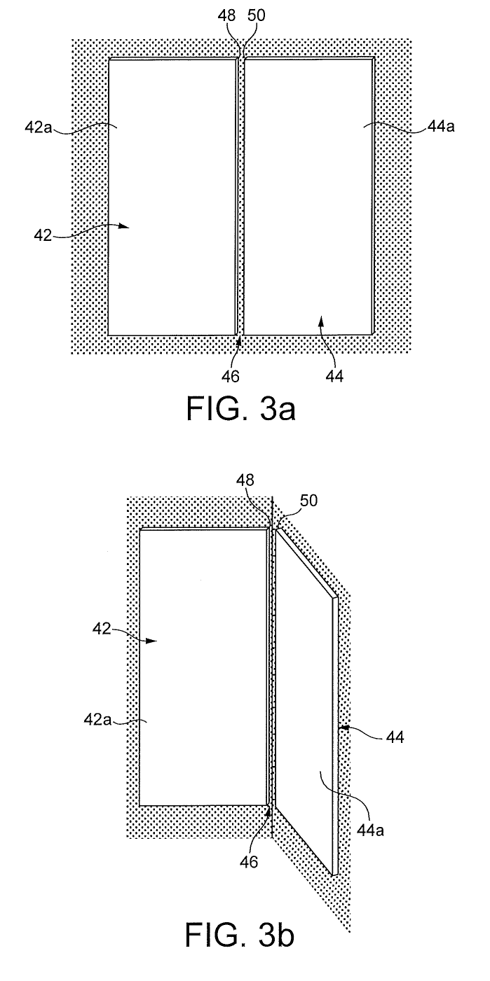

FIG. 3a shows a schematic illustration of part of a replaceable fluid container having a measurement sensor with a first electrode and a second electrode, both positioned on or in a surface of the fluid container;

FIG. 3b shows a schematic illustration of part of a replaceable fluid container having a measurement sensor with a first electrode positioned on a first wall of the fluid container, which first wall is mutually perpendicular with;a second wall on which a second electrode is positioned;

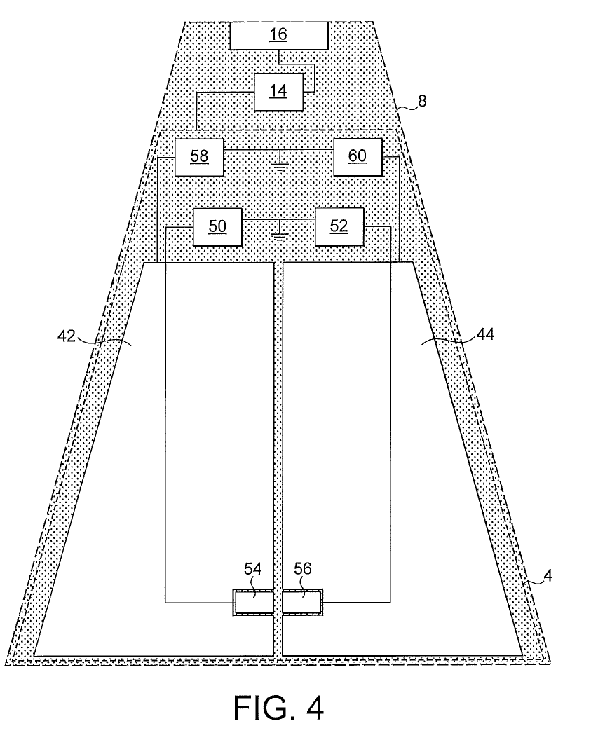

FIG. 4 shows a schematic illustration of part of a surface of a replaceable fluid container, the surface carrying a measurement sensor and a reference sensor;

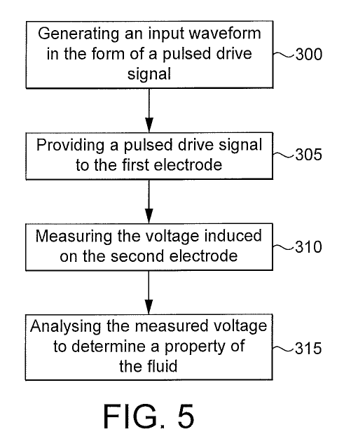

FIG. 5 shows a flow chart illustrating an example of processes involved in a method associated with a measurement of a fluid in a replaceable fluid container using a measurement sensor;

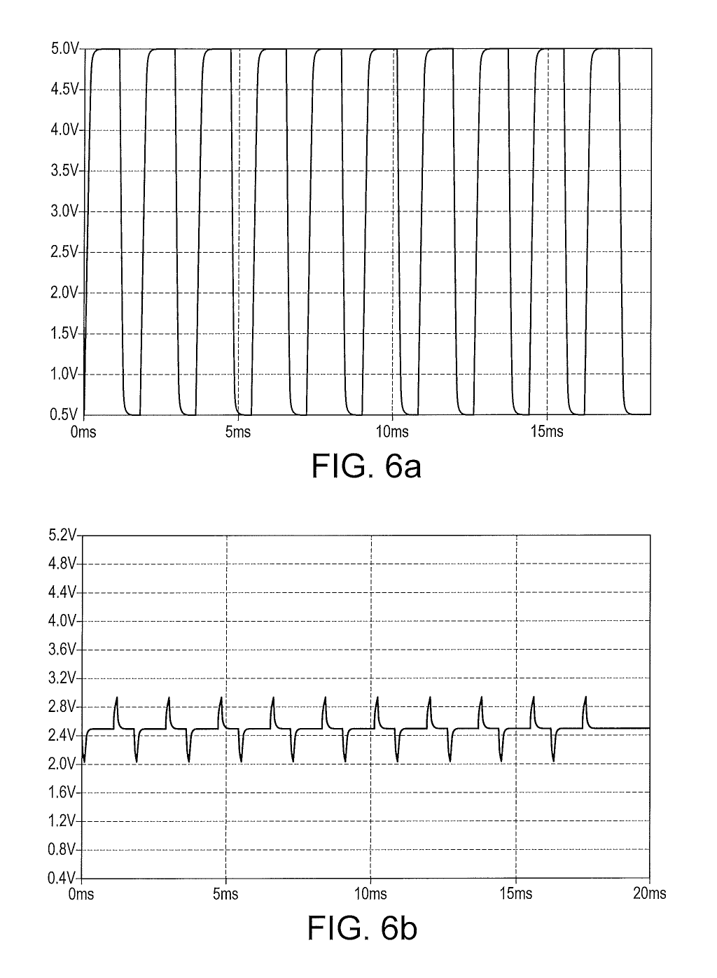

FIG. 6a illustrates an example of an input waveform applied to a first electrode of a sensor; and

FIG. 6b illustrates an example of an output waveform generated on a second electrode by the waveform shown in FIG. 6a being applied to the first electrode of the sensor.

In the present disclosure, and as explained in further detail below, “replaceable” means that:
the container can be supplied full with fresh and/or unused fluid, and/or
the container can be inserted and/or seated and/or docked in the dock, in a non-destructive manner, and/or
the container can be coupled to the fluid circulation system, in a non-destructive manner, and/or
the container can be removed from the dock, in a non-destructive manner, i.e. in a manner which enables its re-insertion should that be desired, and/or
the same (for example after having been refilled) or another (for example full and/or new) container can be re-inserted and/or re-seated and/or re-docked in the dock, in a non-destructive manner.

It is understood that the term “replaceable” means that the container may be “removed” and/or “replaced” by another new container and/or the same container after having been refilled (in other words the replaceable container may be “refillable”) which may be re-inserted in the dock or re-coupled to the fluid circulation system.

In the present disclosure, “in a non-destructive manner” means that integrity of the container is not altered, except maybe for breakage and/or destruction of seals (such as seals on fluid ports) or of other disposable elements of the container.

Embodiments of the present disclosure provide, as shown for example in FIG. 1a, a replaceable fluid container 8 for an engine, the replaceable fluid container comprising: at least one fluid port 2 adapted to couple with a fluid circulation system of the engine when the replaceable container 8 is coupled to a dock; a data provider 4 configured to provide analog data characteristic of at least one of the fluid and the container 8; an analog-to-digital converter 14 configured to convert analog data from the data provider 4 into digitized data; and an interface 16 configured to provide the digitized data unprocessed to a dock interface 18 for supply to a processor 20 configured to process the unprocessed digitized data to provide an indication of a property of at least one of the fluid and the container 8.

FIG. 1a shows the replaceable fluid container 8 located within a dock 22 so that, in this configuration, the dock interface 18 is coupled to the interface 16 of the fluid container 8 and the at least one fluid port 2 is coupled to a fluid port receiver 24 of the dock 22.

The at least one fluid port 2 is configured to transfer fluid to and/or from the fluid container. The fluid port receiver 24 of the dock is configured to receive fluid from and/or to return fluid to the fluid container. Although only one fluid port 2 and one fluid port receiver 24 are shown in FIG. 1a, the container may have a fluid inlet port and a fluid outlet port each configured to couple with a respective fluid port receiver of the dock. The container may also have a vent or breather port configured to couple with a corresponding fluid port receiver of the dock.

In the example illustrated by FIG. 1a, each fluid port receiver 24 is coupled to a fluid circulation system (not shown) associated with an engine or a vehicle to enable fluid from a replaceable container docked with the dock to pass between the fluid container and the fluid circulation system. In this example the fluid flows from the fluid receiver of the dock into a fluid circulation system associated with an engine.

In the example shown in FIG. 1a, the fluid container 8 comprises a fluid reservoir 6 that is located within the fluid container. As another possibility, the wall of the fluid container 8 may also be the wall of the fluid reservoir, for example the wall of the fluid container may define the reservoir in which the fluid is held.

The data provider 4 is configured to provide data characteristic of at least one of the fluid and the container. As an example, the data provider 4 may comprise a measurement sensor configured to measure a property of the fluid and/or fluid container. As another possibility or additionally the data provider may comprise a data store storing data corresponding to a characteristic of at least one of the fluid and the container.

The measurement sensor may be, for example, any one or more of a resistive sensor, a capacitive sensor, a temperature sensor, an optical sensor, a level sensor, or any other sensor suitable for measuring a property or characteristic of at least one of the fluid and the container.

FIG. 1b illustrates an example of the conversion of an analog signal 26 from the data provider 4 to a digital signal 30 by the analog-to-digital converter 14. As shown in FIG. 1b, the analog-to-digital converter 14 receives an analog signal 26 from the data provider 4, for example an analog signal 26 associated with a measurement of a property of the fluid in the fluid container. The analog-to-digital converter 14 samples the signal at a given or set frequency, for example at 10 kSamples/s, to determine the magnitude of the signal at discrete time intervals corresponding to the sampling frequency and so to provide digitised data 30 comprising the magnitude of the signal at each of a number of discrete times with a time interval therebetween determined by the sampling frequency.

In the example illustrated by FIG. 1a and FIG. 1b, the analog-to-digital converter 14 receives unprocessed analog data from the data provider 4 and converts the unprocessed analog data into unprocessed digital data for transmission to the dock interface 18 from the fluid container interface 16. Transmission of data from the fluid container interface 16e to the dock interface 18 in a digital rather than an analog form may reduce the susceptibility of the transmission to interference or noise.

By unprocessed digital data is meant data that has not been subject to processing by way of an algorithm or the like to determine the required information, that is the characteristic or property of the fluid and/or the container. In some examples, the unprocessed data is raw data from the sensor. The analog-to-digital converter 14 and/or the interface 16 may comprise functionality for filtering the data prior to and/or after digitization so as to provide filtered unprocessed analog and/or filtered unprocessed digital data, respectively. The analog-to-digital converter 14 and/or the interface 16 may be capable of encrypting the unprocessed digital data prior to transmission to the dock interface 18 so as to provide encrypted unprocessed data. The unprocessed digital data may or may not be both filtered and encrypted.

In the example illustrated by FIG. 1a, the processor 20 of the dock is configured to receive the unprocessed digital data. The processor 20 is configured to decrypt the unprocessed digital data if it has been encrypted and to process the unprocessed digital data by way of an algorithm or the like to analyse the unprocessed digital data to determine a characteristic or property of at least one of the fluid and the container.

The characteristic or property may be at least one of a level of fluid in the fluid container, a dielectric constant of the fluid, an optical quality of the fluid, a temperature of the fluid, a viscosity of the fluid, a capacitance of the fluid, a characteristic of the container which can be used to identify the container (such as its colour), a characteristic of the container which can be used to identify wear of the container, a specification of the container which can be used to identify its suitability for fitment to a particular vehicle, the number of times the container has been fitted, the frequency of connection and disconnection of the container in the vehicle (e.g. to allow measurement of an intermittent contact between the container and the vehicle), calibration information relating to the sensor, encryption decoding information.

The data provider 4 may comprise a measurement sensor. The analog-to-digital converter 14 and container interface 16 may be provided by a controller such as a microcontroller or the like with associated memory, with the controller managing communications with the dock interface, carrying out the analog-to-digital conversion and running sensing algorithms to control operation of the measurement sensor. The measurement sensor may include amplification/sensing circuitry, for example in the form of an operational amplifier circuit.

The processor 20 associated with the dock 22 may be a controller such as a microcontroller or the like with the controller managing communication (which may be encrypted communication) with the interface 16 and (so with the measurement sensor) and with the vehicle where the dock is carried by a vehicle, for example with a communications (e.g. controller area network (CAN) bus that couples with the engine control unit (ECU) or engine management system. Where the dock is carried by a vehicle, power supply to the components of the dock and any container docked to the dock may be derived from the vehicle power system, for example its battery.

The sensor may include both a measurement sensor and a reference sensor to provide a reference for use by the processor 20 in processing the unprocessed digital data from the measurement sensor.

Embodiments of the present disclosure provide a replaceable fluid container for an engine, the fluid container comprising: at least one fluid port adapted to couple with a fluid circulation system; a sensor comprising a first electrode and a second electrode; wherein the first electrode and the second electrode each extend along a surface of the fluid container and are spaced apart along the surface to define a fluid channel between the first electrode and the second electrode; and wherein the first electrode and the second electrode are configured to be coupled by the fluid such that the application of an input waveform induces an output waveform on the second electrode. In examples, the sensor comprises a capacitive sensor. The replaceable fluid container may be as shown in FIG. 1a and/ or as described above with the sensor comprising the measurement sensor provided by the data provider 4.

FIG. 2 illustrates an example of a sensor comprising a first electrode 42 spaced apart from a second electrode 44 to define a fluid channel 46. In operation, the first electrode 42 is coupled to a signal provider 58 and the second electrode 44 is coupled to a signal receiver 60. The signal provider 58 is configured to provide an input waveform to the first electrode 42 generating an electric field 38 within the fluid channel 46 and inducing an output waveform on the second electrode 44. The signal receiver 60 is configured to measure the output waveform induced at the second electrode 44.

The signal provider 58 may comprise a voltage source and the signal receiver 60 may be configured to provide a voltage output responsive to the induced output waveform. The input waveform may be a pulsed waveform for example a PWM signal. The signal provider 58 may comprise an operational amplifier circuit. The signal receiver 60 may comprise an operational amplifier circuit configured to provide a voltage output responsive to the induced output waveform.

Where the replaceable fluid container is as shown in FIG. 1a, then the processor 20 and the dock interface 18 may be configured to provide the signal provider 58 whilst the container interface 16 may be configured to provide the input waveform to the first electrode 42 either directly or, where the analog-to-digital converter is provided by a controller such as a microcontroller or the like, via that controller. The signal receiver 60 may comprise part of the data provider 4 or, where the analog-to-digital converter is provided by a controller such as a microcontroller or the like, functionality provided by that controller.

The first and second electrodes 42 and 44 are in this example disposed relative to the fluid volume within the container such that the position along the fluid channel reached by the fluid is dependent upon the volume (and so level) of fluid in the container (or reservoir). For example the fluid channel may extend in a direction normal to, a base of the container (or reservoir),

The coupling between the first and second electrodes 42 and 44, and so the induced output waveform, is dependent upon the characteristics of the medium in the fluid channel and the degree to which the fluid channel is filled by fluid. The degree to which the fluid channel is filled by fluid will depend upon the volume of fluid in the container (or reservoir). Any space above the fluid in the container (or reservoir) will of course be occupied by fluid vapour and/or air (herein collectively “gas”). In this example, the fluid provides a dielectric medium and the coupling provided by the fluid is generally capacitive.

The sensor may be carried by a surface of the container wall (or a surface of a reservoir if the container contains a reservoir) and that surface, or at least that surface in the location of the sensor should be electrically insulative.

The container may carry shielding to ameliorate the effects of stray electromagnetic fields on the sensor.

The medium in the fluid channel is, as set out above, in this example dependent upon the level of fluid in the container (or reservoir), and therefore the ratio of fluid to gas in the container (or reservoir). In the example illustrated in FIG. 2 as the volume of fluid in the container (or reservoir) is reduced the medium in the fluid channel comprises a greater volume of gas relative to fluid.

In this example, the relative permittivity of the medium in the fluid channel will influence the capacitive coupling of the first and second electrodes in accordance with:

$$C = {ɛ}_{0} {ɛ}_{r} \frac{A}{d}$$

where C is the capacitance, ∈ₐ is the permittivity of air, ∈ᵣ is the relative permittivity of the medium in the fluid channel, A is the area of the opposed surfaces (edges as shown in FIG. 2) of the first and second electrodes 42 and 44 and d is the separation of the first and second electrodes 42 and 44.

Thus the higher the relative permittivity of the medium in the fluid channel the higher the capacitance. The effective relative permittivity of the medium in the fluid channel and therefore the waveform induced on the second electrode is dependent upon the level of fluid in the fluid channel.

Altering the spacing between the opposed edges of the first and second electrodes will alter the capacitance. In the example illustrated in FIG. 2, the edge of the first electrode is separated from the edge of the second electrode so that there is a constant distance between the two edges. The actual size of the gap between the first and second electrodes will depend upon a number of factors but may be for example 2 mm.

The relative permittivity of the fluid may be data accessible to the processor 20 (for example from a data store associated with the processor and/or with the engine control unit) and/or may be stored in a memory associated with the data provider. The sensor may include both a measurement and a reference sensor to provide reference data such as for example a measurement indicating the relative permittivity (or capacitance) of the fluid.

In example embodiments, a replaceable fluid container for an engine comprises at least one fluid port adapted to couple with a fluid circulation system; a sensor comprising a first electrode and a second electrode; wherein the first electrode, and the second electrode each extend along a surface of the fluid container and are spaced apart along the surface to define a fluid channel between the first electrode and the second electrode; and wherein the first electrode and the second electrode are configured to be coupled by the fluid such that the application of an input waveform induces an output waveform on the second electrode. The first and second electrodes may be provided or formed on or in the surface which may be an interior or exterior surface of the container (or reservoir). For example, the first and second electrodes may be plated onto, deposited in-situ or formed as plates that are adhered to the surface or moulded into the surface. In some examples, the first and second electrodes are provided on an interior surface of the container (or reservoir). The replaceable fluid container may be as described above with reference to FIG. 1a and may interface with a dock as described above.

As mentioned above, the fluid container may have shielding to ameliorate the effects of stray electromagnetic fields. For example, a ground plane carried by the container (or reservoir) may provide shielding. In some examples, the container may have an electrically grounded plate and the sensor may be provided between the electrically grounded plate and fluid contained within the container. For example the electrically grounded plate may be on an outside surface of the container (or reservoir).

FIGS. 3a and 3b show schematic illustrations of part of a replaceable fluid container having a measurement sensor with first 42 and second 44 electrodes both positioned on or in a surface of the fluid container.

In the example illustrated in FIG. 3a, the first electrode 42 has a major surface 42a in about the same plane as a major surface 44a of the first electrode 44 and the fluid channel 46 is defined by opposing edges 48 and 50 of the first and second electrodes 42 and 44. In the example shown, the first and second electrodes are on the same wall of the container (or reservoir)

In the example illustrated in FIG. 3b the first electrode 42 and the second electrode 44 are mutually perpendicular. In this example the major surface 42a of the first electrode 42 is in a plane that is approximately perpendicular to that of the major surface 44a of the first electrode 44. The edge 48 of the first electrode 42 is spaced apart from the edge 50 of the second electrode 44 to define a fluid channel 46 between the first electrode and the second electrode. In the example shown in FIG. 3b, the first and second electrodes are on adjacent walls of the container (or reservoir). It will be appreciated that major surfaces 42a and 44a first and second electrodes need not necessarily be perpendicular or parallel but could be transverse to one another, depending upon the cross-sectional shape of the container (or reservoir) and the relationship of adjacent walls of the container (or reservoir).

As mentioned above, the sensor may comprise a measurement sensor and a reference sensor. The reference sensor may comprise a first reference electrode and a second reference electrode, configured to be coupled by the fluid such that the application of an input reference waveform to the first reference electrode induces an output reference waveform at the second reference electrode. In some examples, the first and second reference electrodes are arranged such that the reference sensor is not responsive to the level of fluid in the container when the level is above a minimum level, that is for example the first and second reference electrodes may be submerged in the fluid when the fluid level is above a minimum level. The measurement sensor may measure a level of fluid in the fluid container whilst the reference sensor may measure a property such as the relative permittivity of the fluid. The first reference electrode and the second reference electrode may be located closer to a base or bottom of the container (or reservoir) than the first measurement electrode and the second measurement electrode. As another possibility, the first reference electrode and the second reference electrode may be located at a position intermediate of a length of the first measurement electrode and the second measurement electrode. For example, the first reference electrode may located in a recess in the first measurement electrode and the second reference electrode may be located in a recess in the second measurement electrode.

The first and second measurement electrodes may extend transverse of, for example perpendicular to, abase of the fluid container such that changes to level of the fluid changes the proportion of the electrode coupled to the fluid. For example, as the fluid level decreases the fluid between the first and second measurement electrodes decreases. FIG. 4 shows a schematic illustration of part of a surface of a replaceable fluid container where the surface carries a measurement sensor and a reference sensor each having first and second electrodes. In this example, the first and second measurement electrodes 42 and 44 each have a shape defined by a region of the container (or reservoir) surface at which they are located. In an example, the first and second measurement electrodes 42 and 44 may be located at a guide groove or protrusion (shown by the dashed line in FIG. 4) and so may have a tapering shape.

As shown in FIG. 4, the first measurement electrode 42 is coupled to the signal provider 50 that is configured to provide an input waveform to the first electrode 42 and the second measurement electrode 44 is coupled to the signal receiver 52 that is configured to measure an output waveform on the second electrode 44, for example as discussed above with reference to FIG. 2.

In the example shown in FIG. 4 the first reference electrode 54 is coupled to a signal provider 50 and the second reference electrode 56 is coupled to a signal receiver 52 of the reference sensor. The signal provider 50 of the reference sensor is configured to provide an input waveform to the first reference electrode 54 of the reference sensor and the signal receiver 52 of the reference sensor is configured to measure an output waveform induced on the second reference electrode 56 by that input waveform. The signal provider 50 and the signal receiver 52 may be provided by the same functionality as the signal provider 58 and the signal receiver 60, respectively. It will be appreciated that, in the example illustrated in FIG. 4, the reference sensor and measurement sensor should, to avoid cross-talk, not be operated at the same time. In other examples the reference sensor may be positioned at a distance from the measurement sensor so that reference sensor and measurement sensor may be operated at the same time.

The reference sensor shown in FIG. 4 may be configured to measure an inherent property of the fluid, such as its relative permittivity, and to that end the reference sensor may be positioned such that the fluid between the electrodes is independent of a volume of a fluid in the container (or reservoir) above a predetermined volume. For example, the first and second reference electrodes may be located such that they are below a minimum level of fluid in the container (or reservoir) above.

In the example illustrated in FIG. 4, the first and second reference electrodes 54 and 56 are received within respective portions of the first and second measurement electrodes 42 and 44. In an example the first and second measurement electrodes 42 and 44 each have a cut-out section that corresponds to the shape of the first and second reference electrode 54 and 56, respectively. In the example shown in FIG. 4 the spacing between the opposing edges of the first and second reference electrodes 54 and 56 is equal to the spacing between the opposing edges of the first and second measurement electrodes 42 and 44 apart of course from at the location of the cut-out sections. This may enable the measurement sensor to be used to provide an indication as to whether the fluid level is sufficient for the reference sensor to sense the fluid property because the effect of the cut-out sections on the induced output waveform of the measurement sensor will be dependent upon the fluid level and so should enable a determination from the output of the measurement sensor when the fluid level is at the level of the cut-out sections.

It will be appreciated that the measurement sensor and reference sensor may be calibrated at factory level and/or during servicing. Calibration data may be stored by the data provider for supply to the processor 20 and/or the measurement sensor and reference sensor outputs may be referenced to initial measurement sensor and reference sensor outputs received by the processor on first docking of the fluid container with the dock.

Each of the examples shown in FIGS. 3a, 3b and 4 may have the shielding discussed above.

As described above with reference to FIG. 1a, the data provider 4 is coupled to the analog-to-digital converter 14 which in turn is coupled to the interface 16 of the fluid container. In the example illustrated in FIG. 4 data from the signal receiver 52 of the reference sensor and the signal receiver 60 of the measurement sensor are received by the analog-to-digital converter 14 which, as described in FIG. 1b, converts the analog signal from the signal receiver 52 of the reference sensor or the signal receiver 60 of the measurement sensor as the case may be into a digital signal. This digital signal is then provided to the dock interface 16 as discussed above.

The measurement and reference sensors are not active at the same time because, as will be appreciated, the application of the input waveform on the first measurement electrode may lead to a voltage being induced on the first and second reference electrodes and as well as the second electrode of the measurement sensor and the application of the input waveform on the first reference electrode may lead to a voltage being induced on the first and second measurement electrodes. In an example, the measurement sensor and the reference sensor may be operated in sequence or alternately. For example, an input waveform may be applied to the first measurement and the output waveform on the second measurement electrode is measured. Then, an input waveform applied to the first reference electrode and the output waveform on the second reference electrode measured. As discussed, above, applying the input waveform such that an input waveform is not applied simultaneously to both the measurement and reference sensors reduces the cross-talk between the measurements.

FIG. 5 shows a flow chart illustrating an example of processes involved in a method associated with a measurement of the fluid using a measurement sensor carried by a fluid container which may be any of the fluid containers discussed above. At 300 in FIG. 5, an input waveform is generated by the signal provider 58. In this example the signal provider 58 generates a pulsed drive signal. The pulsed drive signal, as described in more detail below, may comprise periodic voltage pulses. At 305, the pulsed chive signal is provided to the first measurement electrode by the signal provider. The pulsed drive signal induces an electrical field in the fluid, coupling the first measurement electrode to the second measurement electrode and, in turn, the field induces a voltage on the second measurement electrode. At 315, the signal receiver 60 then measures the voltage induced on the second measurement electrode. At 320 a processor (for example the processor 20 of FIG. 1a) analyses the measured data to determine a property of the fluid, such as for example the fluid level. Processes analogous to those shown in FIG. 5 may be carried out for the reference sensor, if one is present on the fluid container for example to determine a property of the fluid such as its relative permittivity. As discussed above, the measured data may be provided from the container as raw, unprocessed digital data which may have been filtered and encrypted, that is the analysis to determine the fluid property or characteristic (e.g. fluid level and/or relative permittivity) may be carried out “off container”, for example by the processor 20 of the dock shown in FIG. 1a or may be by another processor not located on the fluid container, for example a processor of an engine control unit associated with the fluid container.

FIG. 6a and FIG. 6b show an example of the input waveform and the output waveform. The input waveform of FIG. 6a comprises a clipped square wave. The clipped square wave;may be produced by the signal provider by converting a PWM (pulse-width modulation) signal to a triangular waveform using an RC (resistor-capacitor) circuit and then clipping off the peaks and troughs. This waveform is used in this example to reduce the rate of change in the voltage applied to the first electrode. Limiting the rate of change of the input waveform applied to the first electrode reduces the magnitude of the induced waveform on the second electrode. The waveform may be a clipped triangular waveform. The gradient or rate of change of the clipped triangular waveform should be less steep than a square waveform such that the induced voltage on the second electrode is within a measurable range.

In the example shown in FIG. 6a, the input waveform comprises a periodic signal with a given or set frequency. The output waveform shown in and FIG. 6b is analysed based on the given or set frequency of the input waveform. The inducing of the output waveform on the second electrode by the input waveform on the first electrode is such that the frequency of the output waveform corresponds to the frequency of the input waveform. The given or set frequency may be selected to facilitate filtering of the output waveform to ameliorate the effect of external or stray electromagnetic fields. For example, the environment of an engine interference may lead to additional noise in the output waveform. The output waveform may be filtered based on frequency, for example any signal in the output waveform that does not correspond to the frequency of the input waveform may be removed from the output waveform. The resulting signal should thus correspond to the components in the output waveform that have been induced by the input waveform applied to the first electrode.

As shown in FIG. 6b, the output waveform in this example has both positive and negative spikes. This signal waveform is supplied to the analog-to-digital converter 14 which outputs a digitised signal which is supplied unprocessed (but perhaps filtered and/or encrypted) from the container. The processor of the dock determines the amplitude of the waveform maxima and minima. In an example, the signal provider (measurement and/or reference) and the signal receiver (measurement and/or reference) may be provided by a microcontroller which in order to make a measurement or reference sensor measurement creates a positive (or negative) edge on a digital output pin, then samples the returning signal from the second electrode using an analogue input pin, for example up to 4 samples. The sampling speed may be about 10 k Samples/s for a 10 bit ADC. The process is repeated for the opposite going edge, so that falling edge peak signals and rising edge trough signals are acquired to enable a difference between values to be obtained to remove any DC offset. This process of drive and sample is repeated a number of times over a sample period (for example one second), with the sample signals being accumulated (but not averaged) over this time period. Generally to improve the signal-to-noise ratio, the measurement sensor is driven and sampled far more often than the reference sensor. For example, for every 180 times the measurement sensor is driven and sampled (90 for each of the positive and negative going edges), the reference sensor is driven and sampled 10 times by the reference sensor (5 for each of the positive and negative going edges). The communication to and from the sensor may use logic level RS232 serial communication and the data may be transmitted at a rate of 9600 baud with a period of more than 3 ms between data packets.

The dock and/or the container may comprise a temperature sensor. The processor of the dock may use the temperature measured by the temperature sensor to determine the temperature of the fluid in the fluid container. The processor may apply a correction to the temperature measurement to determine the temperature of the fluid in the fluid container from the dock temperature sensor. Far example, the dock temperature sensor may be positioned at a given distance from the container and a correction factor may be applied in order to compensate for the distance from the temperature sensor to the fluid. The measured temperature may be used, for example to assist in determining a property or characteristic of the fluid. Thus, for example, the output waveform induced by the input waveform may be dependent upon temperature. The temperature dependence of the output waveform may then be compensated for using the measured temperature, for example a weighting may be applied to the output waveform based on the measured temperature and the weighted output waveform compared to a data base or look-up table to determine the level of fluid.

In an example the measurement sensor is used to measure the level of fluid in the fluid container. As shown in FIG. 6a and FIG. 6b a measurement may be made by analysing the response of the second electrode to the application of a periodic signal to the first electrode. The periodic input waveform may induce a periodic output waveform on the second electrode. In an example, the difference between peak and trough values for a given input waveform may be compared to a data base or look up table and the level of fluid determined by that comparison.

The raw data provided by the container interface may be accumulated, for example accumulated level peak values and/or accumulated level trough values derived from the measurement sensor data, raw accumulated reference peak values and/or accumulated reference trough values derived from the measurement sensor data, accumulated samples from a container temperature sensor such as a thermistor circuit, accumulated samples from a temperature sensor of the container.

Processing of the digitised raw data (which may have been filtered) is carried out by a processor not on the container, as described above the dock processor 20, after decryption, if the digitised raw data has been encrypted. A fluid level in the container may be determined by the off-container processor by determining a difference between accumulated peak and accumulated trough values derived from the measurement sensor data and by using one or more data bases or look-up tables to determine a corresponding level value. Reference values may be determined as the difference between accumulated peak and accumulated trough values derived from the reference sensor data and then using a data base or look-up table to determine dielectric changes, e.g. changes in the relative permittivity of the fluid. Temperature compensation may be achieved using, for example a temperature determined by a temperature sensor carried by the container. The dock may be able to detect its own temperature using an on-board thermistor and an internal temperature sensor of the processor. These may be used to verify the dock's health, and may be reported back to the engine control.

As discussed above, the measurement and reference sensors are not driven at the same time; they are driven and sampled independently to reduce the likelihood of cross-talk between the two sensors. This may be achieved by alternating reference and measurement sensor measurements or by for example making all or a group of the measurement sensor measurements then making all or a group of the reference sensor measurements, or vice versa, thereby reducing the time delay that may otherwise arise in switching between analog channels if the reference and measurement operations are interlaced.

The sensor data may be continuously or periodically (for example once a second) transmitted or data may be transmitted on request by the processor.

The dock processor 20 may monitor current flow to the sensor (by for example measuring a voltage drop across a resistor) to enable detection of the connection status and current consumption of the components on the container enabling reporting back of a connected or disconnected status and a normal or abnormal (out of limits) current consumption to the engine control unit.

The dock processor may also read and/or write data to a memory or data store of the data provider of the container. This data may be encrypted and may include vehicle data and sensor parameters. Data storage may be earned;out at start-up and periodically as a vehicle carrying the container accumulates miles of distance travelled and duration of engine running.

In some examples, upon connection of a sensor, or at vehicle start-up, a process of interrogating the sensor microcontroller is undertaken. Depending on the status of the sensor a Diffie-Hellman key (or a Diffie-Hellman-Merkle key) exchange process may be instigated to establish secure communications between the dock and sensor. It will be appreciated that any suitable encryption procedure may be used.

It is understood that the term “replaceable” means that the container may be “replaceable” by a new container and/or the same container after having been refilled (in other words the replaceable container may be “refillable”).

In the example illustrated by FIG. 1a, the processor 20 of the dock is configured to receive the unprocessed digital data. As another possibility or additionally, the decryption and/or processing of the unprocessed digital data may be earned out in the engine or vehicle and/or remotely, for example at a service station and/or a processor coupled to the dock via a communications link such as a wireless communications link and/or a network which may include one or more of a LAN, WAN or the Internet.

The dock may, as discussed above, be a physical structure in which the container is seated and docked. As another possibility, the dock may simply be a fluid coupling or couplings of the engine fluid circulation system for coupling to the at least one fluid port of the container.

The electrodes of a described measurement or reference sensor may also be used for determining temperature, for example a measurement provided by the sensor may be compared to a data base or look up table which relates a value of a dielectric constant of the fluid to temperature.

It will be appreciated that embodiments described above may be combined. For example, the fluid container of FIG. 1a may or may not use any one of the sensors shown in FIG. 2, 3a, 3b or 5.

A replaceable fluid container that provides digitized data unprocessed to an interface of the dock coupled to a processor configured to process the unprocessed digitized may or may not use a sensor comprising first and second electrodes each extending along a surface of the fluid container and spaced apart;along the surface to define a fluid channel between the first and second electrodes, and vice versa. Also any described fluid container may or may not have a reference sensor and/or temperature sensing functionality.

A method of determining a property of a fluid in a replaceable fluid container for an engine that provides a drive signal to a first electrode and measures the voltage induced on a second electrode need not necessarily use a sensor comprising first and second electrodes each extending along a surface of the fluid container and spaced apart along the surface to define a fluid channel between the first and second electrodes, any suitable sensor having first and second electrodes may be used.

In the examples illustrated above, the first and second electrodes are provided in or on adjacent walls of the surface and the adjacent walls correspond to the walks) of the container. In some examples, this surface may also include an interior wall of the fluid container. In some examples, the interior surface of the container may comprise at least one discontinuity. For example the fluid container may comprise at least one interior wall (in some examples the interior wall may include a rib or a fin) and one of the first and second electrodes may be provided on the interior wall, so that the first and second electrodes are adjacent to one another, possibly opposed to one another depending upon the relative position of the interior wall and the wall of the container.

In some examples, the least one discontinuity may provide an inner surface positioned within an outer surface. The interior wall of the container may be located within a spaced bounded or defined by the wall of the container or the container may comprise multiple interior walls which may be located within a space defined by another. For example, the interior wall and the wall of the container may be concentric or the multiple interior walls may be concentric.

The sensor may be a “tube-in-tube” sensor having the first electrode on the inner wall and the second electrode on the other wall that is located within the space defined by the outer wall. The walls may comprise an open top or apertures in the inner and/or outer wall to allow fluid into the volume provided between the inner and outer walls. In this example the capacitance may be measured in the radial gap between the inner and outer walls. In an example the inner and outer walls have a circular cross section.

Suitable vehicles include motorcycles, earth moving vehicles, mining vehicles, heavy duty vehicles and passenger cars. Powered water-borne vessels are also envisaged as vehicles, including yachts, motor boats (for example with an outboard motor), pleasure craft, jet-skis and fishing vessels. Also envisaged, therefore, are vehicles comprising a system of the present disclosure, or having been subject to a method of the present disclosure, in addition to methods of transportation comprising the step of driving such a vehicle and uses of such a vehicle for transportation.

The container 2 may be manufactured from metal and/or plastics material. Suitable materials include reinforced thermoplastics material which for example, may be suitable for operation at temperatures of up to 150° C. for extended periods of time.

The container 2 may comprise at least one trade mark, logo, product information, advertising information, other distinguishing feature or combination thereof. The container 2 may be printed and/or labelled with at least one trade mark, logo, product information, advertising information, other distinguishing feature or combination thereof. This may have an advantage of deterring counterfeiting. The container 2 may be of a single colour or multi-coloured. The trademark, logo or other distinguishing feature may be of the same colour and/or material as the rest of the container or a different colour and/or material as the rest of the container. In some examples, the container 2 may be provided with packaging, such as a box or a pallet. In some examples, the packaging may be provided for a plurality of containers, and in some examples a box and/or a pallet may be provided for a plurality of containers.

With reference to the drawings in general, it will be appreciated that schematic functional block diagrams are used to indicate functionality of systems and apparatus described herein. It will be appreciated however that the functionality need not be divided in this way, and should not be taken to imply any particular structure of hardware other than that described and claimed below. The function of one or more of the elements shown in the drawings may be further subdivided, and/or distributed throughout apparatus of the disclosure. In some embodiments the function of one or more elements shown in the drawings may be integrated into a single functional unit.

The above embodiments are to be understood as illustrative examples. Further embodiments are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

In some examples, one or more memory elements can store data and/or program instructions used to implement the operations described herein. Embodiments of the disclosure provide tangible, non-transitory storage media comprising program instructions operable to program a processor 2 to perform any one or more of the methods described and/or claimed herein and/or to provide data processing apparatus as described and/or claimed herein.

The activities and apparatus outlined herein may be implemented using controllers and/or processors which may be provided by fixed logic such as assemblies of logic gates or programmable logic such as software and/or computer program instructions executed by a processor. Other kinds of programmable logic include programmable processors, programmable digital logic (e.g., a field programmable gate array (FPGA), an erasable programmable read only memory (EPROM), an electrically erasable programmable read only memory (EEPROM)), an application specific integrated circuit, ASIC, or any other kind of digital logic, software, code, electronic instructions, flash memory, optical disks, CD-ROMs, DVD ROMs, magnetic or optical cards, other types of machine-readable mediums suitable for storing electronic instructions, or any suitable combination thereof.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination, with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and, scope of the invention. It is therefore intended to cover in the appended claims all such changes and modifications that are within the scope and spirit of this invention.

1. A replaceable fluid container for an engine, comprising:
at least one fluid port adapted to couple with a fluid circulation system of the engine when the replaceable container is coupled to a dock;
a data provider configured to provide analog data characteristic of at least one of the fluid and the container;
an analog-to-digital converter configured to convert analog data from the data provider into digitized data; and
an interface configured to provide the digitized data unprocessed to an interface of the dock for supply to a processor configured to process the unprocessed digitized data to provide an indication of a property of at least one of the fluid and the container.

2. The replaceable fluid container of claim 1, wherein the data provider is configured to encrypt the digitized data to provide encrypted unprocessed digital data to the dock interface.

3. The replaceable fluid container of any preceding claim 1, wherein the data provider comprises at least one sensor configured to measure a property of the fluid.

4. The replaceable fluid container of claim 3, further comprising a data store coupled to the data provider, wherein the data store is configured to store data from the at least one sensor.

5. The replaceable fluid container of claim 4, wherein the data provider is configured to receive data from at least one sensor at a rate of 10 kSample/s.

6-7. (canceled)

8. The replaceable fluid container of claim 1, wherein the analog-to-digital converter is configured to sample received analog data at a rate of 10 kSample/s.

9. The replaceable fluid container of claim 1, further comprising a memory configured to store data associated with the container.

10. The replaceable fluid container of claim 1, further comprising a filter to filter the data prior to the provision of the unprocessed digital data to the dock interface.

11. A method of determining a property of a fluid in a replaceable fluid container for an engine, the fluid container comprising a sensor for sensing a characteristic of the fluid, the sensor having a first electrode and a second electrode, the method comprising:
providing a drive signal to the first electrode; and
measuring the voltage induced on the second electrode by the drive signal provided to the first electrode to provide a measure of the characteristic of the fluid.

12-14. (canceled)

15. The method of claim 11, further comprising a reference sensor having a first reference electrode and a second reference electrode, wherein the method comprises providing a reference drive signal to the first reference electrode; and
measuring the voltage induced on the second reference electrode by the reference drive signal.

16-19. (canceled)

20. A replaceable fluid container for an engine, the fluid container comprising:
at least one fluid port adapted to couple with a fluid circulation system;
a sensor comprising a first electrode and a second electrode;
wherein the first electrode and the second electrode each extend along a surface of the fluid container and are spaced apart along the surface to define a fluid channel between the first electrode and the second electrode; and
wherein the first electrode and the second electrode are configured to be coupled by the fluid such that the application of an input waveform induces an output waveform on the second electrode.

21. The replaceable fluid container of claim 20, wherein the first electrode and the second electrode are provided in or on the surface of the fluid container.

22. The replaceable fluid container of claim 20, wherein the surface has a plurality of walls and the first and second electrodes are provided in or on the same wall of the surface.

23. The replaceable fluid container of claim 20, wherein the first and second electrodes lie in the same plane.

24. The replaceable fluid container of claim 20, wherein the surface has a plurality of walls and the first and second electrodes are provided in or on adjacent walls of the surface.

25. The replaceable fluid container of claim 24, wherein the adjacent walls are mutually perpendicular such that the first electrode extends perpendicularly of the second electrode.

26. The replaceable fluid container of claim 20, wherein the surface is an interior surface of the container.

27. The replaceable fluid container of claim 26, wherein the interior surface of the container comprises at least one discontinuity.

28. The replaceable fluid container of claim 27, wherein the least one discontinuity provides an inner surface positioned within an outer surface.

29. The replaceable fluid container of claim 20, wherein the container has a ground plane to shield the sensor from stray electrical fields.

30. The replaceable fluid container of claim 20, wherein the container has an electrically grounded plate and the sensor is provided between the electrically grounded plate and fluid contained within the container.

31. The replaceable fluid container of claim 20, wherein the fluid channel is defined between edges of the first and second electrodes.

32. The replaceable fluid container of claim 20, wherein the first electrode and the second electrode are arranged such that the sensor is responsive to the level of fluid in the container when the volume of fluid in the container is below a predetermined volume.

33. The replaceable fluid container of claim 20, further comprising a reference sensor comprising a first reference electrode and a second reference electrode, wherein the first reference electrode and the second reference electrode are configured to be coupled by the fluid such that the application of an input reference waveform to the first reference electrode induces an output reference waveform at the second reference electrode.

34. The replaceable fluid container of claim 33, wherein the first and second reference electrodes are arranged such that the reference sensor is not responsive to the level of fluid in the container when the level is above a minimum level.

35-36. (canceled)

37. The replaceable fluid container of claim 20, wherein at least one of the input waveform or input reference waveform comprises a pulsed signal.

38. The replaceable fluid container of claim 20, further comprising a temperature sensor.

39. The replaceable fluid container of claims 20, wherein a temperature is measured using one or more of the electrodes.

40. A replaceable fluid container for an engine, comprising:
at least one fluid port adapted to couple with a fluid circulation system;
a measurement sensor comprising a first measurement electrode and a second measurement electrode; and
a reference sensor comprising a first reference electrode and a second reference electrode;
wherein the measurement sensor is configured to provide an output dependent upon the level of fluid within the container; and
wherein the reference sensor is configured to provide an output independent of the level of fluid within the container.

41. The replaceable fluid container of claim 40, wherein the first measurement electrode and the second measurement electrode are separated by a distance that is equal to a distance separating the first reference electrode and the second reference electrode.

42. The replaceable fluid container of claim 40, wherein the first reference electrode and the second reference electrode are located at a position intermediate of a length of the first measurement electrode and the second measurement electrode.

43. The replaceable fluid container of claim 41, wherein the first reference electrode is located in a recess in the first measurement electrode and the second reference electrode is located in a recess in the second measurement electrode.

44. The replaceable fluid container of claim 40, wherein the first electrode and the second electrode of the reference sensor are positioned adjacent the bottom of the first electrode and the second electrode of the measurement sensor.

45. The replaceable fluid container claim 40, wherein the at least one sensor is a reference sensor, and wherein the reference sensor is configured to measure a property of the fluid.

46. The replaceable fluid container of claim 40, wherein the at least one sensor is a measurement sensor, and wherein the measurement sensor is configured to measure a level of fluid in the fluid container.
